(19) United States
(12) Patent Application Publication
(10) Pub. No.: US 2009/0298368 A1
(43) Pub. Date: Dec. 3, 2009

(54) Composition for Continuous Inkjet Finishing of a Textile Article

(76) Inventors: Johannes Antonius Craamer, Ijlst (NL); James E. Fox, Cambridge (GB)

Correspondence Address: HOWREY LLP-EU, C/O IP DOCKETING DEPARTMENT, 2941 FAIRVIEW PARK DR., SUITE 200, FALLS CHURCH, VA, 22042, US

(21) Appl. No.: 11/886,714

(22) PCT Filed: Mar. 22, 2006
(86) PCT No.: PCT/EP2006/060967

§ 371 Date: Sep. 20, 2007

(30) Foreign Application Priority Data
Mar. 22, 2005 (GB) 0505879.7

(51) Int. Cl. C09D 5/00; B32B 9/00; B05D 1/02

(52) U.S. Cl. 442/79; 252/8.61; 252/8.62; 252/8.63; 106/15.05; 442/91; 442/102; 442/103; 442/105; 442/107; 442/110; 442/123; 442/131; 442/148; 427/421.1

(57) ABSTRACT

A finishing composition is proposed for deposition by continuous flow inkjet technique onto a textile substrate. The composition comprises a dispersion or emulsion of a functional finishing agent in a vehicle and the jetted composition has a conductivity of greater than 500 μS/cm. The size of particles in the dispersion or emulsion of the finishing composition is less than about 5 microns. By ensuring sufficient fineness of the particles, effective and reliable droplet deposition may proceed without clogging of the nozzles.

### BACKGROUND OF THE INVENTION

1. Field of the Invention

The present invention relates to finishing textiles and more particularly to finishing of textiles by digital droplet deposition using continuous inkjet (CIJ) techniques. It relates furthermore to finishing compositions specially adapted to this purpose and methods of performing such finishing.

2. Description of the Related Art

The production of textiles traditionally takes place in a number of distinct processes. Roughly five production stages can be distinguished in traditional textile production: the fibre production; spinning of the fibres; the manufacture of cloth (for instance woven or knitted fabrics, tufted material or felt and non-woven materials); the upgrading of the cloth; and the production or manufacture of end products. Textile upgrading is a totality of operations which have the purpose of giving textile the appearance and physical characteristics that are desired by the user. Textile upgrading comprises of, among other things, preparing, bleaching, optically whitening, colouring (dyeing and/or printing) and finishing a textile article.

The conventional process for upgrading textile is built up (see FIG. 1) of a number of part-processes or upgrading steps, i.e. pre-treating the textile article (also referred to as the substrate), dyeing the substrate, coating the substrate, finishing the substrate and the post-treatment of the substrate.

A known technique for printing textile is the so-called template technique. Ink is applied to cut-out leaves or elements, the templates, with which desired patterns such as letters and symbols can be applied to the substrate. Another known technique for printing textile is the so-called flatbed press technique, wherein the printed image lies in one plane with the parts of the print mould not forming a printing area. An example hereof is a so-called offset print, wherein the printing process takes place indirectly. During the printing the print area is first transferred onto a rubber fabric tensioned round a cylinder and from there onto the material for printing. A further technique is screen-printing, wherein the substance for applying is applied through openings in the print template onto the textile for printing.

As is already indicated in FIG. 1, dyeing of the substrate is another upgrading step. Dyeing is the application of a coloured chemical substance in a full plane, and then uniformly in one colour. Dyeing takes place at present by immersing the textile article in a dye bath, whereby the textile is impregnated with a coloured substance, visible on both sides of the substrate.

One form of finishing is coating. Coating of a textile involves the application of a thin layer to the textile to endow it with particular functional properties such as to protect or increase the durability of the substrate. The usual techniques for applying a coating on solvent or water basis are the so-called “knife-over-roller”, the “dip” and the “reverse roller” screen coaters. A solution, suspension or dispersion of a polymer substance in water is usually applied to the cloth and excess coating is then scraped off with a doctor knife. For such procedures to be effective, the coating formulation must be in a highly viscous, pasty form. For many functionalities, it is not possible to bring the formulation into such a viscous state without adversely affecting the functionality. This may be due to the fact that thickening agents are incompatible with the functional chemical.

A further procedure sometimes employed for finishing of the textile is the use of immersion or bath techniques such as foularding. The textile is fully immersed in an aqueous solution containing the functional composition that is to be applied. Subsequent repeated cycles of drying, fixation and condensation are required to complete the operation. This leads to considerable use of resources, in particular water and energy. In general, the solutions, suspensions or dispersions used for such techniques have low concentrations of the desired functional composition

Each of the upgrading steps shown in FIG. 1 consists of a number of operations. Various treatments with different types of chemicals are required, depending on the nature of the substrate and desired end result.

For the upgrading steps of printing, dyeing and finishing, four recurring steps can generally be distinguished which often take place in the same sequence. These treatments are referred to in the professional field as unit operations and include: impregnation (i.e. application or introduction of chemicals); reaction/fixing (i.e. binding chemicals to the substrate); washing (i.e. removing excess chemicals and auxiliary chemicals); and drying.

One drawback of the usual methods of upgrading is that per upgrading step (dyeing, coating, finishing) a number of cycles of unit operations have to be carried out to achieve the desired result. Three or more cycles of unit operations are often necessary for coating, which entails a relatively high environmental impact, a long throughput time and relatively high production costs. Four or more cycles of unit operations are even required for dyeing. The traditional dyeing process requires, for instance, the final operations of several rinses (washing and soaping) for rinsing out excess chemicals, such as thickening agent. Rinsing results in much use of water. Following on from the rinses is a drying process, usually consisting of a mechanical drying step using press-out rollers and/or vacuum systems followed by a thermal drying step, for instance using tenter-frames.

It is moreover usual at this moment to carry out the different upgrading steps of the textile in separate devices. This means that for instance the dyeing is performed in a number of dye baths specially suitable for the purpose, the printing and coating are carried out in separate printing devices and coating machines, while finishing is carried out by yet another device. Because the different operations are carried out individually in separate devices, the treating of the textile requires a relatively large area, usually spread over different room areas.

It has been suggested in a number of publications that a textile article may be printed using ink-jet printing technology to produce a graphic image. Ink formulations from the graphic (paper) printing sectors have generally been used for this purpose, as such formulations are already adapted for jet deposition. In particular, pigment particulate sizes and the relatively low solids contents make such inks most suitable for inkjet devices. Such formulations are not however entirely suitable for application to all textiles, in particular those where considerable absorbency is encountered. In the past, textile articles have been pretreated with a coating onto which ink droplets may be applied using standard graphic printing techniques. A process is known from U.S. Pat. No. 4,702,742 in which a conventional printing device is used to print onto white cloth sheets. A further process is suggested in German patent application No. DE 199 30 866 in which both ink and a fixing solution are applied to a textile using a conventional inkjet head. Known methods are however only concerned with producing a graphic image and the formulations used are unsuitable as coatings for finishing.

It has also been suggested in unpublished PCT application Nos PCT/EP2004/010732 and PCT/EP2004/010731 both filed on 22 Sep. 2004, to use inkjet type nozzles for the purpose of upgrading textile substrates. The proposed method makes use of a device comprising a number of nozzles for applying one or more substances to the textile, in addition to a conveyor for transporting the textile along the nozzles. The nozzles are ordered in a number of successively placed rows extending transversely of the transporting direction of the textile article. The textile article is guided along a first row of nozzles where it may receive a first functional layer. It may then be subsequently guided along second or third rows of nozzles for receiving further functional layers. Such a process may be referred to as digital droplet deposition.

The previously proposed method provides the option of applying chemical substances in concentrated form and with an exact dosage. The desired upgrading result can thereby be achieved in only a single cycle of unit operations. By applying the chemical substances in only one process run using a number of rows of nozzles placed in series, the efficiency per process run is increased considerably. Very uniform layers can also be applied due to the precision of dosage and nozzles control that is possible. The relatively high concentration with which the chemical substances may be applied furthermore makes interim drying almost unnecessary in many cases. The nozzles of the proposed device are preferably static with the textile being guided along the nozzles. This enables relatively high processing speeds and very precise forming of patterns. A further advantage of digital droplet deposition, is that it provides the possibility of on-demand delivery. Smaller series of different textile articles can be processed on a single upgrading device without complicated change-over operations which can have an adverse environmental and productivity impact.

It has also been suggested in unexamined patent application No. JP61-152874 to Toray Industries, to impregnate a textile sheet with a functional composition in the form of dots. Various functional compositions are suggested including antibiotics, moisture absorbents, water repellents, antistatic agents, ultraviolet rays absorbents, infrared rays absorbents, optical whitening agents, swelling agents, solvents, saponifier, embrittlement agent, inorganic granules, metal granules, magnetic material, flame retardants, resistance, oxidants, reducing agents, perfumes, etc. The document indicates that traditional photogravure roll and screen print methods produce patterns of dots that may be too large, while in spraying techniques, the dot size and quantity of product deposited is difficult to control. The document proposes impregnating a textile with a functional composition in the form of dots, wherein a mean dot diameter is 30 to 500 microns and the occupied area ratio thereof is 3 to 95%. Although the document suggests the use of inkjet printing techniques, it identifies conventional inkjet devices as being unsuitable, in particular due to the high viscosity of traditional coating compositions. The document is concerned primarily with maintaining an identifiable droplet structure and preventing the droplets from running together. Furthermore, the document provides examples regarding the use of solutions but fails to address the problems of inkjet deposition of dispersions or suspensions.

Inkjet printers of various types are generally known for providing graphic images. Such printers may be desktop inkjet printers such as used in the office or home and are generally used for printing onto a particular type of paper substrate (printer paper), using small droplets (<20 pL) of water based inks containing colorants. Larger, industrial inkjet printers also exist for printing graphic images or date/batch codes onto products; these printers are typically printing onto non-porous substrates using solvent based inks containing colorants pigments. Such formulations are not however suitable for application to most textiles in particular due to lack of colour fastness. In order to print onto textiles using inkjet techniques, textile articles have in the past been pretreated with a coating onto which ink droplets may be applied. For upgrading purposes, most currently used coatings and finishing compositions are unsuitable for deposition using inkjet techniques. Industrial inkjet printers and nozzles that produce large droplets are generally designed for use with solvent based, coloured inks. Furthermore, the droplet volumes that can be jetted are extremely low, in the order of 50 pL and mostly insufficient for textile finishing, where a significant penetration into the fabric is necessary. Typical finishing formulations are mostly water based and generally have particle sizes that can cause clogging of the nozzles. Additional problems with foaming, spattering and encrustation have been encountered. When working with large numbers of nozzles operating continuously at up to 100 KHz, reliability and fault free operation are of prime importance. While indicating that conventional inkjet devices are unsuitable for applying finishing compositions, JP61-152874 fails to provide teaching regarding how this could be improved.

A preferred form of digital droplet deposition makes use of the continuous inkjet (henceforth CIJ) technique with multi-level deflection. In the continuous method, pumps or pressure in a reservoir, carry a constant flow of agent to one or more very small outlets of the nozzles. One or more jets of agent are ejected through these outlets. Under the influence of an excitation mechanism such a jet breaks up into a constant flow of droplets of the same size. The most used excitator is a piezo-crystal although other forms of excitation or cavitation may be used. From the constant flow of droplets generated only certain droplets are selected for application to the substrate of the textile. For this purpose the droplets are electrically charged or discharged. In CIJ, there are two variations for arranging droplets on the textile; binary CIJ and multi-deflection CIJ. According to the binary deflection method, drops are either charged or uncharged. The charged drops are deflected as they pass through an electric field in the print head. Depending on the configuration of the specific binary CIJ printer, the charged drops may be directed to the substrate whilst the uncharged drops are collect in the print head gutter and re-circulated, or vice versa. According to a more preferred method known as the multi-deflection method, the droplets are applied to the substrate by applying a variable level of charge to them before they pass through a fixed electric field, or conversely by applying a fixed level of charge to the drops before they pass through a variable electric field. The ability to vary the degree of the charge/field interaction on the drops means that the level of deflection they experience (and thus their position on the substrate) can be varied, hence ‘multi-deflection’. Uncharged drops are collected by the print head gutter and re-circulated.

The present invention is intended to apply to all such CIJ devices, specifically those operating by: feeding the formulation to the nozzles in almost continuous flows; breaking up the continuous flows in the nozzles to form respective droplets, whilst simultaneously applying an electric field, as required, to charge the droplets; and applying a second electric field so as to deflect the drops such that they are deposited at suitable positions on the textile article.

Use of CIJ makes it possible to generate 64,000 to 125,000 droplets per second per droplet jet. This large number of droplets and a number of mutually adjacent heads over the whole width of the textile results in relatively high productivity and quality of the printed result. In view of the high deposition speed, a production speed of the textile substrate of about 20 metres per minute can be realized. In view of the small volumes of the reservoirs associated with the nozzles, a product change can also be realized within a very short time (less than two minutes).

Despite the advantages of the above proposed digital finishing procedures it has been found that most currently used coatings and upgrading compositions are unsuitable for deposition using continuous inkjet techniques. Standard inkjet nozzles of the continuous flow type are generally adapted for use with solvent-based inks. Furthermore, when using CIJ to print high quality graphics, the droplet volumes that can be jetted are extremely low, in the order of 50 pL, and mostly insufficient for textile coating where a significant penetration into the fabric is necessary. Typical coating formulations are mostly water based and generally have particle sizes that can cause clogging of the nozzles especially when high solid content formulations are jetted. Additional problems with foaming, spattering and encrustation have been encountered. When working with large numbers of nozzles operating continuously at up to 100 KHz, reliability and fault free operation are of prime importance.

### BRIEF SUMMARY OF THE INVENTION

According to the present invention, there is proposed a finishing composition for deposition by continuous flow inkjet technique onto a textile substrate, the composition comprising a dispersion or emulsion of a functional finishing agent in a vehicle, wherein the jetted composition has a conductivity of greater than 500 μS/cm and the size of particles in the dispersion or emulsion of the finishing composition is less than about 5 microns.

By ensuring sufficient fineness of the particles, effective and reliable droplet deposition may proceed without clogging. In the present context, the term particle is intended to cover solid particles as present in dispersion and also liquid or gel like phases, present e.g. in emulsions. It is noted that 5 microns is an approximate limit for particle size. Preferably, the maximum particle size will be less than 2 microns and for binary deflection continuous inkjet may even need to be less than 0.5 microns. This value will also decrease as the percentage of solids in the composition increases above 10% and will rise as the nozzle diameter increases above 50 microns. It has been found most significant that the formulation is of a consistent quality in this respect. Reference to particle size smaller than a given diameter is thus intended to refer to the D₉₉ diameter or better. The formulation should also not be subject to flocculation or sedimentation. This is intended to mean that the composition does not form particles greater than the given values during prolonged use or when the inkjet device is idle during its normal use. It is understood that many compositions may e.g. form sediment during prolonged storage but that this may be overcome by appropriate mixing arrangements.

In the context of the present invention, the term “finishing” is understood to mean processes that use auxiliary chemicals to change the functionality of a textile substrate rather than merely providing it with a coloured design or changing its visual appearance as is the case with conventional inkjet printing use inks and dyes. These finishing techniques are meant to improve the properties of and/or add properties to the final product In this context it is understood to encompass both coating and impregnating and also to include other physical treatments that upgrade the functionality of the substrate. A distinction will henceforth be made between colouring and finishing. Where necessary, finishing may be understood to exclude treatments involving the deposition of particles that are applied to the substrate only because of their absorption properties between 400 and 700 nm.

The term “finishing composition” herein encompasses aqueous solutions, aqueous dispersions, organic solutions, organic dispersions, curable liquid mixtures and molten compounds that comprise an active component. According to an important advantage of the invention, the composition may be non-reactive with the substrate. In this manner, the composition may be applied to a greater diversity of substrates than would otherwise be the case.

Furthermore, the term “textile” is intended to encompass all forms of textile article, including woven textiles, knitted textiles and non-woven textiles. The term is intended to exclude fibrous articles having two-dimensional rigidity such as carpets, paper and cardboard. These fibrous articles, although sometimes referred to as textiles, are internally linked in such a way that they maintain a substantially fixed two-dimensional form. Even though they may be flexible in a third dimension they are not generally free to stretch or distort within the plane of the fibre layer, as is inherent in a true textile. Preferably the textile substrate is more than 100 meters in length and may be provided on a roll having a width of greater than 1 meter. Preferred textiles comprise cotton and/or other treated cellulosic fibres and also polyesters, polyamides, polyacrylnitril and acetates and triacetates or blends thereof.

According to a further aspect of the invention, the composition may comprise a conductivity agent in sufficient quantity to achieve the required conductivity of greater than 500 μS/cm in the jetted composition. In order to be able to impart a charge onto the droplet, the finishing composition must be sufficiently conductive. For aqueous solutions, where the vehicle is water, the conductivity agent may be a conductivity salt, preferably present at up to 0.5 wt % in the jetted composition. Exemplary salts include lithium nitrate, potassium thiocyanate, polythiophene and dimethylamine hydrochloride. In general, some specific salts such as chlorides are particularly undesirable as they are more corrosive than other salts. The conductivity salts may be selected to give the desired level of conductivity whilst minimising their corrosion promoting effects. Potassium thiocyanate has been found particularly useful for jetting purposes as relatively little is required to achieve the desired conductivity.

According to a preferred embodiment for use with most common finishing agents, the vehicle is distilled, de-mineralized and/or de-ionized water, preferably present at between 50 and 90 wt % in the jetted composition.

According to the present invention there may also be provided a co-solvent, preferably present at around 20 wt % in the jetted composition. Suitable co-solvents include methanol, ethanol and acetone. The co-solvent may be required to provide solubility for the conductivity agent i.e. a small amount of ethanol is used to dissolve a conductivity agent that is not otherwise soluble. According to a further advantage, the co-solvent can also be used to improve the solubility of the finishing agent and/or its compatibility with the conductivity agent. Incompatibility between these materials is a common formulation issue.

According to an important aspect of the present invention, considerably greater quantities of residual solids may be deposited according to the present composition. The finishing composition may comprise a total of residual solids in the jetted composition of more than 5 wt %, preferably more than 10 wt % and most preferably more than 13 wt %. This leads to considerably less energy use in drying and allows greater operational speed.

According to a yet further feature of the invention, the finishing composition may further comprise a humectant, preferably present at up to 5 wt % in the jetted composition. The humectant may usually be in the form of a low volatility, high boiling point liquid that helps prevent crusting of the nozzle when the jets are not active. Suitable humectants include polyhydric alcohols, glycols, glycerol, methoxy propanol and n-methyl pyrrolidone (NMP). Although with certain formulations it may appear that more than 5% humectant is being used, it is in fact the case that the same material may also be present as a viscosity modifier.

The finishing composition may also comprise a viscosity control agent, preferably present at up to 20 wt % in the jetted composition. The viscosity control agent is an important ingredient for increasing reliability and quality as it controls the droplet formation and break up process. This material may also act as an active functional finishing component and provide some of the end user properties. Generally, high molecular weight polymers in solution should be avoided as their elasticity makes achieving jet break up difficult. Suitable viscosity control agents include polyvinylpyrrolidone (PVP), polyethylene oxide, polyethylene glycol, polypropylene glycol, acylics, styrene acrylics, polyethyleneimine (PEI) and polyacrylic acid (PAA). Preferably a viscosity of up to 4 centipoise is desired (lower for binary deposition), as measured at the normal operating temperature of the nozzle.

The finishing composition may further also comprise a surfactant, preferably present at up to 0.5 wt % in the jetted composition. The surfactant is useful in reducing foaming and may also lower surface tension and improve wetting of the nozzle and textile. Exemplary surfactants include anti-foam agents such as polysiloxan and Surfynol DF75™ available from Air Products, and wetting agents such as Surfynol 104E™ and Dynol 604™ available from Air Products. Preferably, the surface tension of the composition is between 25 and 50 dynes/cm. If the surface tension is too high, the composition will not wet the internals of the print head properly and will leave air pockets, which will prevent reliable deposition. If the surface tension of the fluid is too low, the meniscus will not form properly in the print head nozzle and break-up of the fluid will be unreliable.

Moreover, the finishing composition may also comprise a biocide, preferably present at up to 0.5 wt % in the jetted composition. Biocide may be used to prevent bacteria growing in the composition—this may not be required if other components of the composition are sufficiently concentrated to kill bacteria. Exemplary biocides include 1,2-benzisothiazolin-3-one and Proxel GXL™ available from Zeneca Specialties.

The finishing composition may further comprise a pH modifier, preferably present at up to 1 wt % in the jetted composition. The pH modifier may be used to maintain a pH at which the solids of the composition are stably dispersed, typically this is pH>7, so most are alkaline. The pH modifier may also be used to affect the chemistry of the interaction between the composition/active agent and the textile itself. Ammonia, morpholine, diethanolamine, triethanolamine and acetic acid are suitable pH modifiers. Generally, it is desirable from an inkjet perspective to use relatively neutral solutions to reduce corrosion in the printheads.

The finishing composition may also further comprise a corrosion inhibitor, preferably present at up to 0.2 wt % in the jetted composition. The corrosion inhibitor may be used to prevent unwanted ions present in the fluid (usually as impurities coming from the active components) from causing corrosion of the printer.

According to a still further aspect of the present invention, the finishing agent may be chosen for its ability to withstand shear without degradation. In particular it should be stable to shear up to at least 10⁶/s. Continuous flow inkjet deposition is a high shear technique and so material that is not stable to high shear may decompose in the print head nozzle, blocking it or the return gutter and also may cease to provide the desired application or end user properties on the substrate. For CIJ, the shear experienced in the nozzle is greater than by the other inkjet techniques and also the fluid is re-circulated and so may pass through the nozzle many times. For this reason, shear stability is of increased importance for this technique. While the present invention is directed to finishing compositions for CIJ, it is nevertheless considered that the composition would also be suitable for other jet deposition techniques where similar conditions of pressure, shear and nozzle diameter are encountered such as ultra fine valve-jet devices.

The finishing agent may be any appropriate agent that can endow a functional property to a textile substrate. In particular it may be selected from the group consisting of anti-static, anti-microbial, anti-viral, anti-fungal, medicinal, anti-pilling, non-crease, flame-retardant, water-repellant, UV-protective, deodorant, wear-resistant, slip-resistant, slip enhancing, grip enhancing, stain-resistant, oil resistant, adhesive, stiffening, softening, elasticity-enhancing, pigment-binding, conducting, semi-conducting, photo-sensitive, photo-voltaic and light-emitting agents.

For use with drugs or medicinal or biologically active agents a carrier may be used and the agent may be jetted at low temperatures e.g. below 40° C. Appropriate carriers include cyclodextrines, fullerenes, aza-crown ethers and also polylactic acid (PLA). These carriers are ideally suited for attachment both to the textile fibres and to the agent. A review of these carriers is to be found in an article by Breteler et al. in Autex Research Journal, Vol. 2 No 4 entitled Textile Slow Release Systems with Medical Application, the contents of which are hereby incorporated by reference in their entirety. Alternate carriers, particularly for use with nano-particles, may be sol gel systems.

The invention also relates to a method of finishing a textile comprising: providing a continuous supply of a textile substrate; providing an array of continuous flow inkjet nozzles; supplying to the nozzles a finishing composition according to any of the preceding claims; selectively dispensing the composition from the nozzles in a series of droplets to deposit a predetermined distribution of droplets onto the substrate.

According to a feature of the method, the droplets may be dispensed from the nozzles at velocities greater than 15 m/s. The droplets may also be formed at a frequency of greater than 64 KHz. Due to these high speeds and frequencies, textile speeds of up to 20 metres per minute are achievable. It is however of yet greater importance that the properties of the composition are correctly optimized.

Preferably the nozzles are of the multi-level deflection type and droplets are deposited by applying a charge to the droplets and directing them onto the substrate using an electric field whereby either the charge or the field is varied.

A further important feature of the present invention is that the size of the droplet formed can be varied by varying the pump pressure or the excitation frequency for a given nozzle size. By suitable electronic control of these parameters, the droplet size may be controlled. Such control may be varied intermittently e.g. during set-up or calibration but may also be varied on a drop-by-drop basis allowing still further control of the deposited composition.

Also preferable is that more than 30 g/m² of wet composition is deposited on the substrate, more preferably around 50 g/m².

The invention further relates to a textile article provided with a finish comprising the finishing composition as defined above or finished according to the method of the invention.

### BRIEF DESCRIPTION OF THE DRAWINGS

Further advantages, features and details of the present invention will be elucidated on the basis of the following description of a preferred embodiment thereof. Reference is made in the description to the annexed figures, in which:

FIG. 1 shows a schematic block diagram of a conventional process for upgrading a substrate;

FIG. 2 shows a view in perspective of a textile upgrader that may be employed in an embodiment of the invention;

FIG. 3 is a schematic side view of the textile upgrader of FIG. 2;

FIG. 4 is a schematic front view of the textile upgrader of FIG. 2;

FIG. 5 is a cut-away schematic view of the textile upgrader of FIG. 2;

FIG. 6 is a schematic representation of a preferred sequence for performing the different treatment steps for upgrading;

FIG. 7 is a schematic representation of an alternative preferred sequence for performing the upgrading steps;

FIG. 8 is a schematic representation of a further preferred sequence for performing the upgrading steps;

FIG. 9 shows a schematic view of a portion of woven textile coated according to the invention;

FIG. 10 is a cross section through the textile of FIG. 9 along the line 10-10; and

FIG. 11 shows a similar view to FIG. 10 through a coated textile in which smaller droplets have been used.

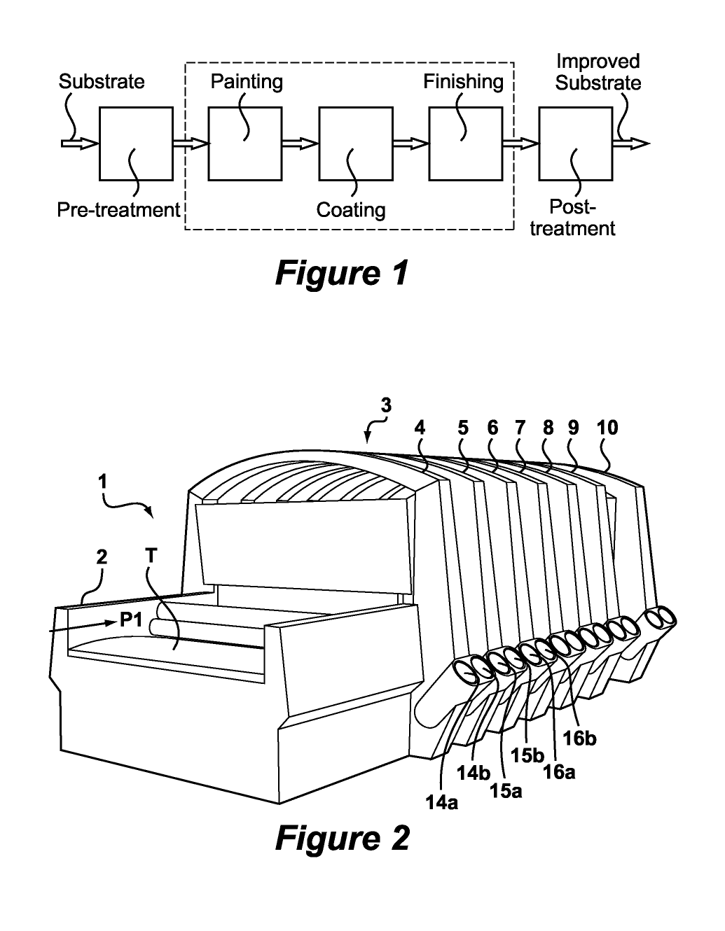

### DESCRIPTION OF ILLUSTRATIVE EMBODIMENTS

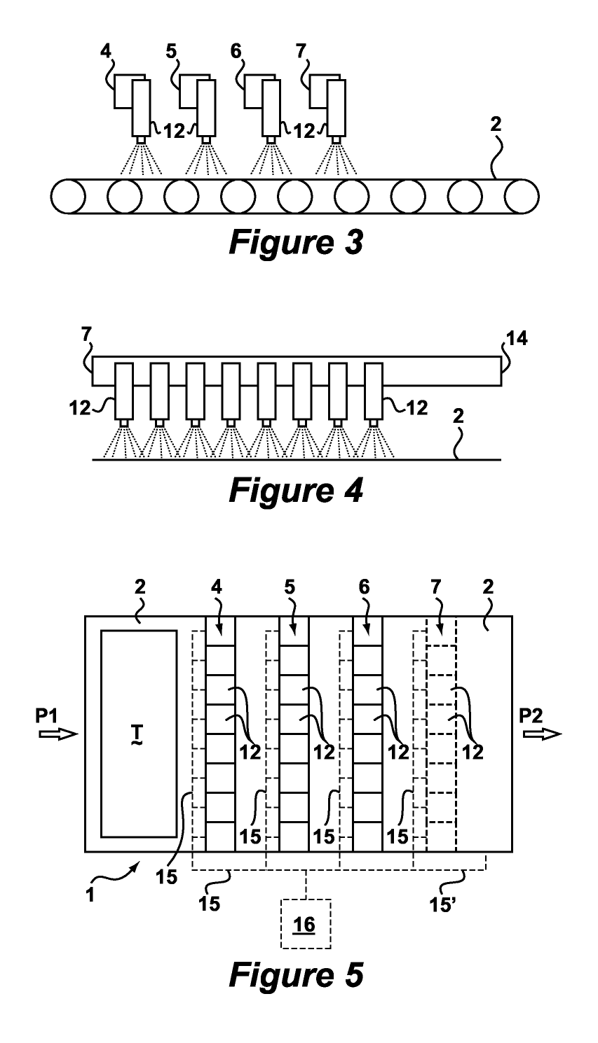

The following is a description of certain embodiments of the invention, given by way of example only and with reference to the drawings. FIGS. 2-5 show a textile upgrader 1 for performing the invention. The upgrader 1 is substantially as suggested in unpublished PCT application Nos PCT/EP2004/010732 and PCT/EP2004/010731. Textile upgrader 1 is built up of an endless conveyor belt 2 driven using electric motors (not shown). On conveyor belt 2 can be affixed a textile article T for transport in the direction of arrow P1 along a housing 3 in which the textile undergoes a number of operations. Finally, the textile may be released and discharged in the direction of arrow P2. A large number of nozzles 12 are arranged in housing 3. The nozzles are arranged on successively placed parallel beams 14. A first row 4, a second row 5, a third row 6 and so on are thus formed. The number of rows is variable (indicated in FIG. 5 with a dotted line) and depends among other factors on the desired number of operations. The number of nozzles per row is also variable and depends among other things on the desired resolution of the designs to be applied to the textile. In a particular preferred embodiment, the effective width of the beams is about 1 m, and the beams are provided with about 29 fixedly disposed inkjet heads, each having about eight nozzles of between 50 and 100 ηm. Each of the nozzles 12 can generate a stream of droplets of ink, dye or finishing composition.

In the CIJ method according to the present invention, pumps or other sources of pressure carry a constant flow of ink through one or more very small holes of the nozzles. One or more jets of ink, inkjets, are ejected through these holes. Under the influence of an excitation mechanism such an inkjet breaks up into a constant flow of droplets of the same size. The most used excitator is a piezo-crystal. From the constant flow of identically sized droplets those droplets are selected which must be applied to the substrate of the textile. For this purpose the droplets are electrically charged or discharged. There are two variations for arranging droplets on the textile according to the CIJ technique. According to the one method an applied electric field deflects the charged droplets, wherein the charged droplets come to lie on the substrate and the uncharged droplets are collected and may be recycled (or vice-versa). This method is also referred to as binary deflection. According to the preferred method, also known as the multi-level deflection method, the electrically charged droplets are usually directed to the textile and the uncharged droplets may be recycled. The droplets are herein subjected to an electric field which is varied between a plurality of levels such that the final position at which the different droplets come to lie on the substrate can be adjusted. Alternatively, the applied charge may be varied and the field kept constant.

In binary CIJ, the nozzles are arranged in a fixed array across the web width and can only print at one specific point each across the width of the web, this means that the nozzle spacing dictates the cross web resolution and many nozzles are required to achieve a sufficiently high cross web resolution. In comparison, multi-deflection CIJ allows one nozzle to address a number of specific points across the width of the web by deflecting the droplet to different levels. This means that the cross web resolution can be varied giving good flexibility and fewer nozzles are required to print the full width at the desired resolution. Minimising the number of nozzles is highly desirable as fewer nozzles gives greater reliability, as well as lower overall printing system cost.

In FIG. 5 is indicated with dotted lines that the different nozzles 12 are connected (electrically or wirelessly) by means of a network 15 to a central control unit 16, which comprises for instance a micro-controller or a computer. The drive of the conveyor belt 2 is also connected to the control unit via network 15′. The control unit can now actuate the drive and the individual nozzles as required.

Also arranged per row of nozzles 4-11 is a double reservoir in which the finishing composition or dye to be applied is stored. The first row of nozzles 4 is provided with reservoirs 14a, 14b, the second row 5 is provided with reservoirs 15a, 15b, the third row 6 is provided with reservoirs 16a, 16b and so on. The appropriate substance is arranged in at least one of the two reservoirs of a row.

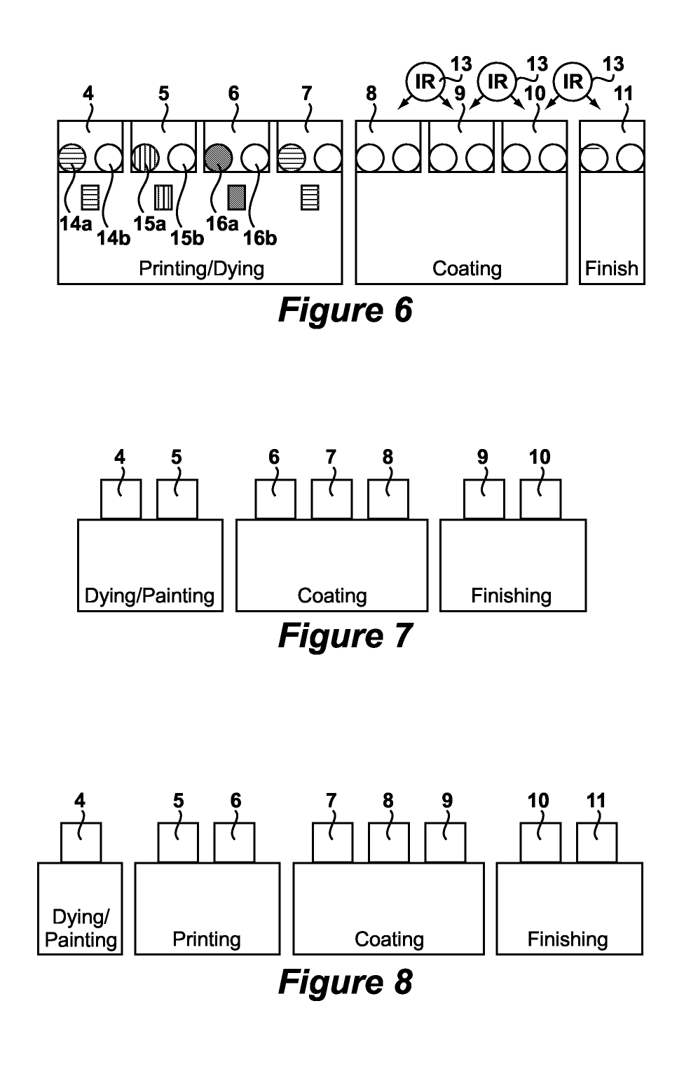

The different reservoirs are filled with appropriate substances and the nozzles 12 disposed in different rows are directed such that the textile article undergoes the correct treatment. In the situation shown in FIG. 6, reservoir 14a of the first row 4 contains cyan-coloured ink, reservoir 15a of the second row 5 contains magenta-coloured ink, reservoir 16a of the third row 6 contains yellow-coloured ink and reservoir 17a of the fourth row 7 contains black coloured ink. The textile article is provided in rows 4-7 with patterns in a dyeing/printing treatment using CIJ nozzles of 50 microns. The reservoirs of the three subsequent rows 8-10 contain one or more finishing compositions according to the present invention, with which the treated textile can be coated in three passages using CIJ nozzles of 70 microns. The reservoir of the eighth row 11 contains a further finishing composition with which the printed and coated textile can be finished. In this case, the nozzles are dot-on-demand thermal inkjets having openings of 30 microns. In this embodiment the textile article T is preferably treated at the position of the fifth to the eighth row with infrared radiation coming from light sources 13 in order to influence the coating and/or the finishing.

FIG. 7 shows another situation in which the textile undergoes another treatment sequence. The textile article T is first of all dyed by guiding the textile along the first row 4 and second row 5 of nozzles. These rows 4, 5 have nozzles of 70 microns and apply a relatively smooth coloured coating onto the textile. In the third to fifth rows 6-8 the dyed textile is then coated as above, whereafter the final finishing step is carried out in the sixth and seventh rows 9,10.

In the embodiment shown in FIG. 8, the textile article is first of all guided along the first row 4 of nozzles. The nozzles in row 4 are of about 70 microns and provide a smooth full background colour to the textile over the full width. The textile article is subsequently guided along the second row 5 and third row 6 by means of the conveyor belt, wherein patterns are printed onto the prepared surface. Good definition can be achieved in the printing steps at rows 5 and 6 using fine nozzles of between 30 and 50 microns. The textile is then guided along the fourth to sixth rows 7-9 to coat the dyed and printed textile in three passages, whereafter a final finishing treatment step is performed in the seventh and eighth rows 10,11.

It is possible to treat different successively transported textile articles in different ways, in some cases even without the transport of the textile therein having to be interrupted. It is for instance possible by means of computer control of nozzles 12 to provide successively supplied textile articles with designs which differ in each case. It is also possible to have different substances applied to the textile through an appropriate choice of the reservoirs. The first reservoirs 14a, 15a, 16a are for instance used in each case for a first type of textile, while the second reservoirs 14b, 15b, 16b are used for another type of textile.

### Example I

A formulation “Man 15 b” according to Table 1 was tested in a Linx 6000 CIJ printer using a 62 micron nozzle. It should be noted that although the flame retardant agent Flammentin KRE™ is present at 10 wt %, it is in a 40% aqueous solution. The overall concentration of functional agent is therefore 4 wt %.

The formulation was found to have the physical properties according to Table 2.

TABLE 1

| Formulation Man | | Percentage By |
|---|---|---|
| 15b | Function | Weight (%) |
| Flammentin KRE | Active flame | 10 |
| (THOR) | retardant | |
| De-ionised water | Medium | 64.75 |
| Polyethylene Glycol | Humectant | 15 |
| 200 (Aldrich) | | |
| PVP K30 (25% in | Viscosity Control | 10 |
| water) (ISP) | | |
| 10% Zonyl FSA | Surfactant | 0.15 |
| (Dupont) | | |
| Proxel GXL1 (ISP)/ | Biocide | 0.1 |
| Nuosept 4912 (ISP) | | |
| Respumit S (10% in | Anti foaming agent | 0.02 |
| DI water) | | |
| Projet Fast Cyan 2 | Indicator | 0.25 |
| (Avecia) | (experimental) | |

| | |
|---|---|
| Total | 100.25 |

TABLE 2

| Properties | |
|---|---|
| Filtration | 1.0 micron, filtered |
| | easily (1500 g) |
| Appearance | Transparent pale |
| | blue. Low foam. |
| Viscosity at 25° C., cP | 3.07 |
| Surface Tension, dynes/cm | 28.7 |
| Conductivity, mS/cm | 8.07 |
| pH | 6.28 |

The Man 15b formulation was jetted at different modulation voltages ranging from 5V to 200V. Drop formation and image quality were analysed and it was found that excellent result were achieved within a broad range of modulation voltages between 30V and 80V. Drop diameter was around 115 microns and drop volume 800 pL. The diameter of the printed dot was 270 microns.

The formulation was then reliability tested at a modulation voltage of 40V (pressure 217). After 90 minutes, jetting was terminated and the head and substrate were examined. No errors were detected in the printed textile. The print head was clean with no visible build-up of formulation.

### Example II

A further formulation for providing an anti-static finish “Avistat 3P” was prepared according to Table 3.

The formulation was found to have the physcial properties according to Table 4.

TABLE 3

| Formulation | | Percentage By |
|---|---|---|
| Avistat 3P | Function | Weight (%) |
| Avistat 3P (THOR) | Antistatic/Charging | 5 |
| | salt | |
| De-ionised water | Medium | 81.33 |
| Polyethylene Glycol | Humectant | 10 |
| 200 (Aldrich) | | |
| PVP K30 (ISP) | Viscosity | 2.5 |
| | Control/Binder | |
| 10% Zonyl FSA | Surfactant | 0.15 |
| (Dupont) | | |
| Nuosept 491 (10%) | Biocide | 1.0 |
| (ISP) | | |
| Respumit S (10%) | Anti foaming agent | 0.02 |
| (Bayer) | | |

| | |
|---|---|
| Total | 100.25 |

TABLE 4

| Properties | |
|---|---|
| Filtration | 1.0 micron, filtered |
| | easily (200 g) |
| Appearance | Transparent |
| Viscosity at 25° C., cP | 2.59 |
| Surface Tension, dynes/cm | 29.3 |
| Conductivity, mS/cm | 5.77 |
| pH | 7.33 |

The above examples illustrate how, in addition to reduced energy consumption, substantially less chemicals are required. With current production techniques about 150 grams of wet substances (chemicals) are applied per square metre. In digital printing, owing to more precise dispensing and less absorption in the textile, the quantity of chemical substances to be applied can be reduced to less than 50 grams of wet substance per square metre. It is hereby possible to make a saving of about 66% in the chemicals. The saving relates not only to the primary chemicals but also to the additives, such as salts, with which the substrate is pre-treated in the digital process in order to facilitate the action, fixation and/or reactivity of the primary chemicals. It is expected that a saving of 66% can also be made on these additives. Finally, waste water production and the contamination impact of the waste water can be reduced by more than 90%.

Although the above examples relate to flame retardant and anti static coatings respectively, similar process parameters may be used for most conventional textile coatings.

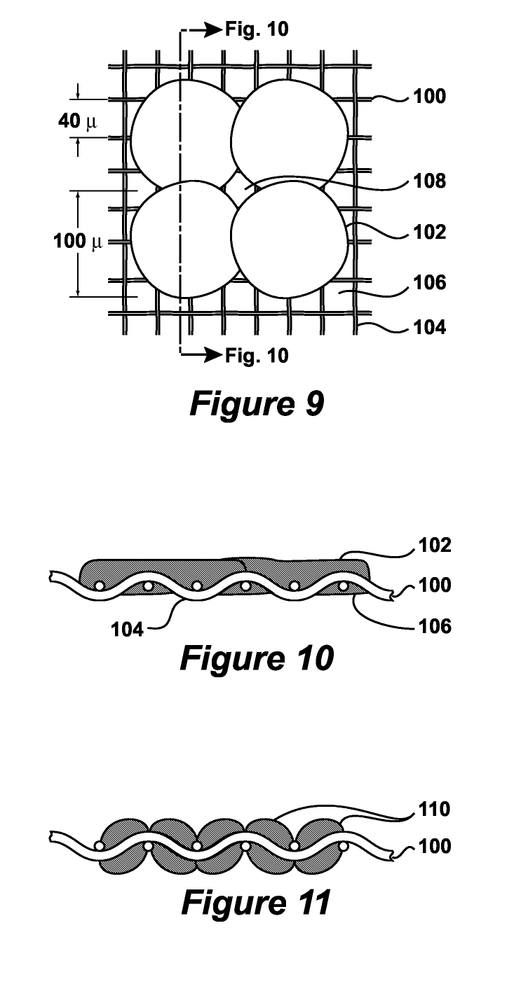

FIG. 9 shows a schematic view of a portion of woven textile 100 on which four pixels 102 of a water repellent coating material have been deposited. The textile 100 comprises fibres 104 arranged in a mesh with mesh openings 106 between the fibres 104. The fibre spacing is approximately 40 microns and the pixels 102 each have a diameter of approximately 100 microns. As can be seen from FIG. 9, each pixel 102 effectively covers at least four complete openings 106. Additionally, it can be seen that the pixels 102 do not form a completely closed coating in that a pore 108 is formed between adjacent pixels 102.

FIG. 10 is a cross section through the textile 100 of FIG. 9 along the line 10-10. It can be seen that the pixels 102 are generally located on the surface of the textile, spanning the openings 106 between adjacent fibres 104. Because of the viscous nature of the coating substance, each pixel 102 partially maintains its shape and although the pixels 102 flow together in the overlap region, the individual pixels are still discernable. It can furthermore be seen that the coating substance forming the pixel 102 partially envelopes the fibres 104 on the coated surface to form a good bond therewith. The viscosity of the coating substance is chosen to ensure the correct degree of impregnation of the material.

FIG. 11 shows a similar view to FIG. 10 taken through a textile 100 in which smaller droplets 110 of a coating substance have been applied. The droplets 110 are of a similar size to the mesh opening 106 and tend to pass into and even through the openings. The resultant effect is less homogenous than in the case of FIG. 10. It may be used to introduce a finishing composition into the substrate rather than provide a surface finish.

While the above examples illustrate preferred embodiments of the present invention it is noted that various other arrangements may also be considered which fall within the spirit and scope of the present invention as defined by the appended claims.

1. A textile finishing composition for deposition by continuous flow inkjet technique onto a textile substrate, the composition comprising a dispersion or emulsion of a functional finishing agent in a vehicle, wherein the jetted composition has a conductivity of greater than 500 μS/cm and the size of particles in the dispersion or emulsion of the finishing composition is less than 5 microns.

2. The finishing composition according to claim 1, wherein the size of particles in the dispersion or emulsion of the finishing agent is less than 2 microns.

3. The finishing composition according to claim 1, wherein the total of residual solids in the jetted composition is more than 5 wt %, preferably more than 10 wt % and most preferably more than 13 wt %.

4. The finishing composition according to claim 1, wherein the vehicle is water, preferably present at between 50 and 90 wt % in the jetted composition.

5. The finishing composition according to claim 1, comprising a conductivity salt, preferably potassium thiocyanate, present at up to 0.5 wt % in the jetted composition.

6. The finishing composition according to claim 1, further comprising a co-solvent, preferably present at 20 wt % in the jetted composition.

7. The finishing composition according to claim 1, further comprising a humectant, preferably present at up to 5 wt % in the jetted composition.

8. The finishing composition according to claim 1, further comprising a viscosity control agent, preferably present at up to 10 wt % in the jetted composition.

9. The finishing composition according to claim 1, further comprising a surfactant, preferably present at up to 0.5 wt % in the jetted composition.

10. The finishing composition according to claim 1, further comprising a biocide, preferably present at up to 0.5 wt % in the jetted composition.

11. The finishing composition according to claim 1, further comprising a pH modifier, preferably present at up to 1 wt % in the jetted composition.

12. The finishing composition according to claim 1, further comprising a corrosion inhibitor, preferably present at up to 0.2 wt % in the jetted composition.

13. The finishing composition according to claim 1, wherein the finishing agent is stable to shear up to at least 106/s.

14. The finishing composition according to claim 1, wherein the finishing agent is selected from the group consisting of anti-static, anti-microbial, anti-viral, anti-fungal, medicinal, non-crease, flame-retardant, water-repellant, UV-protective, deodorant, wear-resistant, stain-resistant, adhesive, stiffening, softening, elasticity-enhancing, pigment-binding, conducting, semi-conducting, photo-sensitive, photo-voltaic and light-emitting agents.

15. A method of finishing a textile comprising:
providing a continuous supply of a textile substrate;
providing an array of continuous flow inkjet nozzles;
supplying to the nozzles a finishing composition according to any of the preceding claims;
selectively dispensing the composition from the nozzles in a series of droplets to deposit a predetermined distribution of droplets onto the substrate.

16. The method according to claim 15, whereby the droplets are dispensed from the nozzles at velocities greater than 15 m/s.

17. The method according to claim 15, whereby the droplets are formed at a frequency of greater than 64 KHz.

18. The method according to claim 15, wherein the nozzles are of the multi-level deflection type and droplets are deposited by applying a charge to the droplets and directing them onto the substrate using an electric field whereby either the charge or the field is varied.

19. The method according to claim 15, further comprising selectively varying the size of the droplet.

20. The method according to claim 15, wherein between 30 and 80 g/m2 of wet composition is deposited on the substrate, preferably around 50 g/m2.

21. A textile article provided with a finish comprising the finishing composition according to claim 1.

22. A textile article finished according to the method of claim 15.
